(19) United States
(12) Patent Application Publication
(10) Pub. No.: US 2024/0247167 A1
(43) Pub. Date: Jul. 25, 2024

(54) THREE-DIMENSIONAL PRINTING WITH VARIABLE DIELECTRIC PERMITTIVITY

(71) Applicant: Hewlett-Packard Development Company, L.P., Spring, TX (US)

(72) Inventors: James William Stasiak, Corvallis, OR (US); Emre Hiro Discekici, San Diego, CA (US); Dennis J. Schissler, San Diego, CA (US)

(21) Appl. No.: 18/289,926

(22) PCT Filed: Jun. 2, 2021
(86) PCT No.: PCT/US2021/035409

§ 371 Date: Nov. 8, 2023

(51) Int. Cl. C09D 177/00; B29C 64/165; B29C 64/264; B29C 64/30; B29K 77/00; B29K 105/04; B33Y 10/00; B33Y 30/00; B33Y 70/00; C08J 9/08; C08J 9/10; C08K 3/04; C09D 7/61; C09D 7/63

(52) U.S. Cl. CPC C09D 177/00; B29C 64/165; B29C 64/264; B29C 64/30; B33Y 10/00; B33Y 30/00; B33Y 70/00; C08J 9/08; C08J 9/10; C09D 7/61; C09D 7/63; B29K 2077/00; B29K 2105/04; C08J 2203/02; C08J 2203/04; C08J 2203/18; C08J 2377/00; C08K 3/04

(57) ABSTRACT

The present disclosure provides methods of three-dimensional printing, including iteratively applying individual build material layers of polyamide particles and selectively applying a fusing agent onto the individual build material layers to form individually patterned object layers. The fusing agent can include water and a radiation absorber. The method can also include selectively applying a pore-promoting agent onto the individual build material layers at some or all of the individually pattered object layers to form a pore-generating region, and iteratively exposing the individual build material layers to electromagnetic energy to generate molten polymer from polyamide particles in contact with the radiation absorber that upon cooling forms fused polymer body. A material used to form the fused polymer body without pores can exhibit a material dielectric permittivity, and the fused polymer body at a location that includes the pores can exhibit a decreased dielectric permittivity.

### BACKGROUND

Methods of three-dimensional (3D) digital printing, a type of additive manufacturing, have continued to be developed over the last few decades. However, systems for three-dimensional printing have historically been expensive, though expenses have been coming down to more affordable levels recently. Three-dimensional printing technology can shorten the product development cycle by allowing rapid creation of prototype models for reviewing and testing, but the concept has been somewhat limited as it relates to commercial production capabilities because the range of materials used in three-dimensional printing is likewise limited. Accordingly, it can be a challenge to three-dimensionally print functional parts with desired physical properties.

### BRIEF DESCRIPTION OF THE DRAWINGS

FIGS. 1A-1C are schematic views of example three-dimensional printing methods using an example multi-fluid kits in accordance with the present disclosure;

FIG. 2 is a flowchart illustrating example methods of making a three-dimensional printed objects in accordance with the present disclosure;

FIG. 3 is a schematic view of example three-dimensional printing systems in accordance with the present disclosure; and

FIGS. 4A-4B are schematic view of example three-dimensional printed objects, including a cross-section thereof, in accordance with the present disclosure.

### DETAILED DESCRIPTION

Modulating mechanical properties of a three-dimensional printed objects or additive manufactured part without changing the polymer build material can include the use of various fluid agents and/or manufacturing methods. With these type of modifications, dielectric properties can also be modified through the use of various processing materials and conditions. In accordance with this, methods of making three-dimensional printed objects, three-dimensional printing systems, and three-dimensional printed objects can related to the inclusion of added porosity of such objects to control dielectric permittivity, either throughout or within different regions of the three-dimensional printed objects. This can be accomplished by generating in sito gases during the build process.

In accordance with this, methods of making a three-dimensional printed objects include iteratively applying individual build material layers of polyamide particles to a powder bed, and based on a three-dimensional object model, selectively applying a fusing agent onto the individual build material layers to form individually patterned object layers of the three-dimensional printed object, wherein the fusing agent can include water and a radiation absorber. Furthermore, based on the three-dimensional object model, the methods include selectively applying a pore-promoting agent onto the individual build material layers at some or all of the individually pattered object layers to form a pore-generating region. The pore-promoting agent in this example includes water and a pore-promoting compound that generates a gas at an elevated temperature. The methods also include iteratively exposing the individual build material layers to electromagnetic energy to generate molten polymer from polyamide particles in contact with the radiation absorber that upon cooling forms fused polymer body. Within the molten polymer, the pore-promoting compound can reach the elevated temperature and generate the gas and displaces the molten polymer leaving pores within the three-dimensional printed object. A material used to form the fused polymer body without pores exhibits a material dielectric permittivity, and the fused polymer body at a location that includes the pores can exhibit a decreased dielectric permittivity that is from about 5% to about 50% of the inherent material dielectric permittivity. In some examples, the pore-generating region can include a single discrete location or multiple discrete locations spanning a single layer or multiple build material layers where the pore-promoting agent was selectively applied resulting in a porous portion or portions with the decreased dielectric permittivity or multiple different decreased dielectric permittivities, and wherein the three-dimensional printed object also includes a portion without the pores exhibiting the material dielectric permittivity. In some examples, in addition to the decreased dielectric permittivity, at a same location, the fused polymer body can exhibit reduced magnetic permeability, reduced electrical conductivity, modified photoluminescence, or a combination thereof. The pore-promoting compound can be present in the pore-promoting agent in an amount from about 0.5 wt % to about 25 wt % relative to a total weight of the pore-promoting agent. In some examples, the pore-promoting compound can include a carbohydrazide, urea, a urea homologue, a carbamide-containing compound, ammonium carbonate, ammonium nitrate, ammonium nitrite, a bicarbonate, or a combination thereof. In some examples, the elevated temperature at which the pore-promoting compound can generate the gas is from about 80° C. to about 250° C. The polyamide particles can include polyamide-6, polyamide-9, polyamide-11, polyamide-12, polyamide-6,6, polyamide-6,12, polyamide copolyamide-12, amorphous polyamide, polyvinylidene fluoride copolyamide-12, thermoplastic polyamide elastomer, polypropylene, or a combination thereof. In additional detail, the radiation absorber can include a metal dithiolene complex, carbon black, a near-infrared absorbing dye, a near-infrared absorbing pigment, metal nanoparticles, a conjugated polymer, or a combination thereof; or both. In some examples, the pore-promoting agent can be part of the fusing agent.

Three-dimensional printing systems include a fusing agent applicator loaded or loadable with a fusing agent including water and a radiation absorber, a pore-promoting agent applicator loaded or loadable with a pore-promoting agent including water and a pore-promoting compound that generates a gas at an elevated temperature, an electromagnetic energy source to expose build material of polyamide particles with electromagnetic energy, and a hardware controller to generate a command. The command in this example directs the fusing agent applicator to iteratively and selectively apply the fusing agent to a build material forming individually patterned object layers where the fusing agent can include water and a radiation absorber. The command further directs the pore-promoting agent applicator to iteratively and selectively apply the pore-promoting agent to the build material of the individually patterned object layer where the pore-promoting agent includes water and a pore-promoting compound, and also directs the electromagnetic energy source to expose the build material with electromagnetic energy to selectively provide an elevated temperature sufficient to generate molten polymer from polyamide particles in contact with the radiation absorber that upon cooling, forms a fused polymer body. Within the molten polymer, the pore-promoting compound reaches the elevated temperature and generates the gas and displaces the molten polymer leaving pores within the three-dimensional printed object. A material used to form the fused polymer body without pores exhibits a material dielectric permittivity, and the fused polymer body at a location that includes the pores exhibits a decreased dielectric permittivity that is from about 5% to about 50% of the inherent material dielectric permittivity. The command can further direct the pore-promoting agent applicator to iteratively apply the pore-promoting agent to a single discrete location or multiple discrete locations spanning multiple individually patterned object layers where the pore-promoting agent is to be selectively applied resulting in one porous portion or multiple porous portions independently exhibiting the decreased dielectric permittivity, and another portion without the presence of the pores exhibiting the material dielectric permittivity. In the three-dimensional printing system, in addition to the reduced dielectric permittivity, at a same location, the fused polymer body can exhibit reduced magnetic permeability, reduced electrical conductivity, modified photoluminescence, or a combination thereof. The pore-promoting compound can include a carbohydrazide, urea, a urea homologue, a carbamide-containing compound, ammonium carbonate, ammonium nitrate, ammonium nitrite, a bicarbonate, or a combination thereof. The hardware controller can direct the application of the pore-promoting agent to control the decreased dielectric permittivity at a voxel scale.

Three-dimensional printed objects can include multiple fused layers of polyamide polymer, including a cooled molten polymer with a first region without gas-generated localized pores and a second region with gas-generated localized pores. The first region can exhibit a material dielectric permittivity and the second region exhibits a decreased dielectric permittivity that is from about 5% to 50% of the material dielectric permittivity. In some examples, the three-dimensional printed object can further include a third region with a different void volume of gas-generated localized pores relative to the second region, wherein the dielectric permittivity of the third region can be different than at the second region, but also exhibits a reduced dielectric permittivity relative to the material dielectric permittivity of the first region. In particular methods that involve three-dimensional printing using a build material of polymer particles, a pore-promoting agent can be selectively applied to the build material. A fusing agent can also be selectively applied to the build material. Generally, the fusing agent can include a radiation absorber that can absorb radiation and convert the radiation to heat. After applying the fusing agent and the pore-promoting agent, the build material can be exposed to radiation. Portions of the build material where the fusing agent was applied can heat up to the point that the polymer particles can become fused together to form a solid layer. At the same time, the heat can cause the pore-promoting compound in the pore-promoting agent to react and form a gas. The gas can become trapped as bubbles in the molten polymer. When the polymer hardens, the bubbles can remain as pores within the polymer matrix. Any size, shape, and number of porous portions can be designed and produced in the three-dimensional printed object by selectively applying the pore-promoting agent. The porous portions can be used to control a dielectric permittivity of the resulting objects. The use of a pore-promoting agent during the three-dimensional printing to introduce pores in the resulting three-dimensional printed objects can be described as nanoparticle infiltration. The resulting three-dimensional printed objects with different regions of different pores can have gradient or spatially varying meta-properties or mechanical properties such as a decrease in a dielectric permittivity. The pores introduced can be macroscopic of mesoscopic throughout the resulting three-dimensional printed objects. Drop-on-demand printing techniques described herein can be used to independently control each voxel of the resulting three-dimensional printed objects physical properties.

For clarity, the term “pores” herein is used to describe small gas-generated openings formed while build material is heated to a softened or molten state so that when a three-dimensional printed object becomes solidified or cooled, the small openings remain, having the appearance of solidified gas bubbles. Pores typically are distributed relatively evenly where pore-promoting agent is applied relatively evenly and have an average particle size from about 1 μm to about 1 mm, from about 1 μm to about 500 μm, or from about from about 2 μm to about 250 μm, for example. The pores can be distributed evenly or relatively evenly within certain regions and can have pore density or volume density.

As used herein, “porosity” in a general context can refer to the presence of pores in the fused polymer matrix. In the context of a specific value, “porosity” can be defined as the volume fraction of void space or void volume in the fused polymer relative to the entire volume of the fused polymer (together with the void volume). The void volume can refer to pores formed by the heat-generated chemical reaction of the pore-promoting compound, and not void spaces designed into the three-dimensional model used for three-dimensional printing the article. Any geometry designed into the three-dimensional object model can be considered features of the “entire volume of the fused polymer” and the fraction of void volume can be based on the pores formed by gas generated by the pore-promoting compound. Additionally, porosity can be measured relative to the entire three-dimensional printed object or relative to porous portion(s) of the three-dimensional printed object (where the pore-promoting agent was applied). In some examples, a porous portion of a three-dimensional printed object made using the methods described herein can have a porosity from about 0.5 vol % to about 50 vol %. In other examples, the porous portion can have a porosity from about 1 vol % to about 30 vol % or from about 5 vol % to about 20 vol %. For example, at 40 vol % porosity with a region of the three-dimensional printed object, that region would have a 60 vol % of fused polymer body or material that defines the pores in that region.

It is noted that when discussing the method of making a three-dimensional printed object, the three-dimensional printing system, or the three-dimensional printed object, such discussions of one example are to be considered applicable to the other examples, whether or not they are explicitly discussed in the context of that example. Thus, in discussing a pore-promoting compound or a dielectric permittivity in the context of the method of making a three-dimensional printed object, such disclosure is also relevant to and directly supported in the context of the three-dimensional printing system, the three-dimensional printed object, or vice versa.

There are two terms often used to describe the dielectric properties of materials. In many engineering applications, the term “dielectric constant” is a commonly used and accepted term. Alternatively, the term “dielectric permittivity” is commonly used in various scientific fields, such as physics. Thus, the term dielectric permittivity is used herein, but the dielectric constant could be interchanged with this term providing the same meaning in the context of the definitions and teachings herein.

### Methods of Three-Dimensional Printing

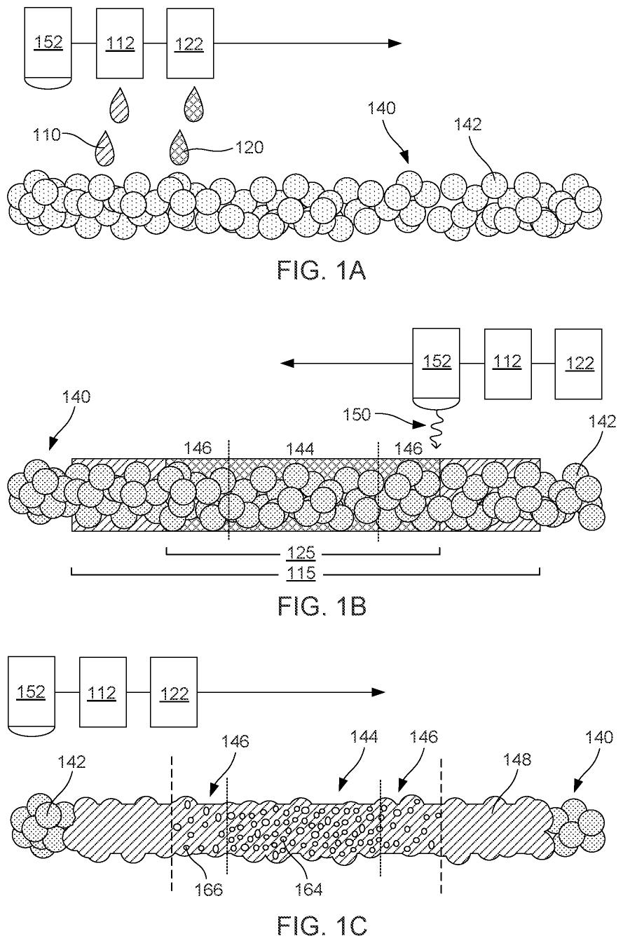

FIGS. 1A-1C illustrate one example of using various materials, such as may be present in certain materials kits, to form a three-dimensional printed object. Example materials that can be used for this example method include a fusing agent 110 and a pore-promoting agent 120. The fusing agent can include water and a radiation absorber. The radiation absorber can absorb radiation energy and convert the radiation energy to heat. The pore-promoting agent can include water and a water-soluble pore-promoting compound. The fusing agent can be applied to a build material in areas that are to be fused to form a layer of a three-dimensional printed object. The pore-promoting agent can be applied to areas of the build material to form pores in the resulting object to control or decrease a dielectric permittivity of the resulting object. The pore-promoting agent can be applied differently to different regions to produce different regions with different dielectric permittivities relative to one another. The build material with no pore-promoting agent can have a dielectric permittivity. The pore-promoting agent and the resulting pores can decrease the dielectric permittivity of the resulting object relative to an object with no pores. In other words, the dielectric permittivity of a build material may be defined as the dielectric permittivity of the build material with no pore-promoting agent and no resulting pores. Decreasing the dielectric permittivity of the resulting object can also result in reduced magnetic permeability, reduced electrical conductivity, modified photoluminescence, or a combination thereof at a region of the resulting object.

The pore-promoting agent can be used to generate both pores, as defined herein. In some examples, in addition to these two fluid agents, there may be other fluid agents, such as a coloring agent, a detailing agent, a second pore-promoting agent, etc. A coloring agent can include a colorant, e.g., dye and/or pigment and an aqueous liquid vehicle. A detailing agent can include a detailing compound, which is a compound that can reduce the temperature of the build material onto which the detailing agent is applied. In some examples, the detailing agent can be applied around edges of the area where the fusing agent is applied. This can prevent build material around the edges from caking due to heat from the area where the fusing agent was applied. The detailing agent can also be applied in the same area where fusing was applied in order to control the temperature and prevent excessively high temperatures when the build material is fused. Three-dimensional printing kits can also include the build material used to form the bulk of the three-dimensional printed object. The build material can include polymer particles, for example. These materials are described in greater detail hereinafter.

Referring now to FIG. 1A more specifically, a fusing agent 110 and a pore-promoting agent 120 are jetted onto a layer of build material 140 including polymer particles 142. The fusing agent is jetted from a fusing agent applicator 112, which may be a fusing agent ejector, and the pore-promoting agent is jetted from a pore-promoting agent applicator 122, which may be a pore-promoting agent ejector. These fluid ejectors can move across the layer of polymer particles to selectively jet fusing agent on areas that are to be fused, while the pore-promoting agent can be jetted onto areas that are to be made porous, or can be jetted at a greater contone level, which relates to the amount of fluid agent applied, of fusing compound onto areas where pores are to be formed that are formed at a greater volume density or porosity or may even in some instances form larger pores. If a detailing agent or other fluid agent were to be used, there may be an additional fluid agent ejector, e.g., detailing agent ejector, coloring agent ejector, second pore-promoting agent ejector, etc. (not shown), that contains the additional respective fluid agent. A radiation source 152 can also move across the layer of build material in some examples, or can be positioned at a fixed location.

FIG. 1B shows the layer of build material 140, which includes polymer particles 142, after the fusing agent has been jetted onto a fusing area 115 of the layer that is to be fused. Additionally, the pore-promoting agent in this example has been jetted onto a pore-generating region 125. In the specific example shown, the pore-promoting agent can be applied at different amounts so that pore-promoting regions can include a first sub-region 144 and a second sub-region 146. The radiation source 152 is shown emitting radiation 150 toward the layer of polymer particles. It should be appreciated that any number of regions or sub-regions can be defined with different amounts of pore-promoting agent applied at each region or sub-region resulting in different dielectric permittivities at each region or sub-region. The fusing agent can include a radiation absorber that can absorb this radiation and convert the radiation energy to heat. Upon heating the polymer to a level of softening or to a molten polymer level, the pore-promoting compound can generate or be generating a gas.

FIG. 1C shows the layer of build material 140 including polymer particles 142 with a fused portion or fused polymer 148 (corresponding to 115 in FIG. 1B) where the fusing agent was jetted. This portion has reached a sufficient temperature to fuse the polymer particles together to form a solid polymer matrix or fused polymer layer. The area where the pore-promoting agent was jetted becomes a porous portion (corresponding with 125 in FIG. 1B). Different amounts of pore-promoting agent applied at different regions can result in a different amount of pores in each region. The pores in one region may be the same size as pores in a different region with the number of pores being different. Alternatively, pores in one region may be a different size than pores in a different region. Additionally, pores in one region may also include different sizes of pores while pores in a different region may only have one size of pores such that the volume of material or density is different in different regions. For example, as depicted, the porous portion includes a first sub-region 144 that includes a first density or volume of pores 164 which are gas-generated, and a second sub-region includes a second density or volume of pores 166 that are also gas-generated. Notably, though the pore size in the various regions are shown as similar in average size, they can be similar or different in average size. Though not shown, the reaction that forms gas bubbles in the molten polymer can form pores that span multiple layers, for example.

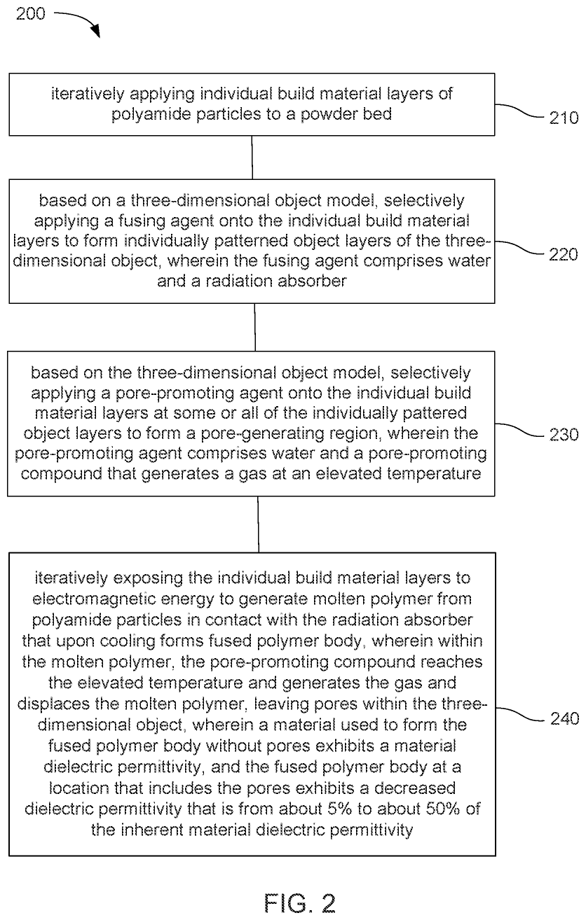

FIG. 2 shows a flowchart illustrating one example method 200 of making a three-dimensional printed object. The method includes iteratively applying 210 individual build material layers of polyamide particles to a powder bed. The method can include, based on a three-dimensional object model, selectively applying 220 a fusing agent onto the individual build material layers to form individually patterned object layers of the three-dimensional printed object, wherein the fusing agent can include water and a radiation absorber. The method can also include, based on the three-dimensional object model, selectively applying 230 a pore-promoting agent onto the individual build material layers at some or all of the individually pattered object layers to form a pore-generating region, wherein the pore-promoting agent can include water and a pore-promoting compound that generates a gas at an elevated temperature. The method can further include, iteratively exposing 240 the individual build material layers to electromagnetic energy to generate molten polymer from polyamide particles in contact with the radiation absorber that upon cooling forms fused polymer body, wherein within the molten polymer, the pore-promoting compound reaches the elevated temperature and generates the gas and displaces the molten polymer, leaving pores within the three-dimensional printed object, wherein a material used to form the fused polymer body without pores exhibits a material dielectric permittivity, and the fused polymer body at a location that includes the pores exhibits a decreased dielectric permittivity that is from about 5% to about 50% of the inherent material dielectric permittivity.

The pore-generating region can include a single discrete location or multiple discrete locations spanning a single layer or multiple build material layers where the pore-promoting agent was selectively applied resulting in a porous portion or portions with the decreased dielectric permittivity or multiple different decreased dielectric permittivities, and wherein the three-dimensional printed object also includes a portion without the pores exhibiting the material dielectric permittivity. Thus, a resulting three dimensional printed object can include different regions with different dielectric permittivities. In some examples, in addition to the decreased dielectric permittivity, at a same location, the fused polymer body can exhibit reduced magnetic permeability, reduced electrical conductivity, modified photoluminescence, or a combination thereof.

The pore-promoting compound can be present in the pore-promoting agent in an amount from about 0.5 wt % to about 25 wt % relative to a total weight of the pore-promoting agent. In some examples, the pore-promoting compound can include a carbohydrazide, urea, a urea homologue, a carbamide-containing compound, ammonium carbonate, ammonium nitrate, ammonium nitrite, a bicarbonate, or a combination thereof. The elevated temperature at which the pore-promoting compound can generate the gas is from about 80° C. to about 250° C. The polyamide particles can include polyamide-6, polyamide-9, polyamide-11, polyamide-12, polyamide-6,6, polyamide-6,12, polyamide copolyamide-12, amorphous polyamide, polyvinylidene fluoride copolyamide-12, thermoplastic polyamide elastomer, or a combination thereof. The radiation absorber can include a metal dithiolene complex, carbon black, a near-infrared absorbing dye, a near-infrared absorbing pigment, metal nanoparticles, a conjugated polymer, or a combination thereof, or both. Polyamide-12 that is used to form a three-dimensional printed object without pores, for example, can have a dielectric permittivity of approximately 3.5. The use of a pore-promoting agent in the printing process to incorporate pores into regions of the three-dimensional printed object can decrease the dielectric permittivity of those regions to less than 3.5.

The fusing agent and the pore-promoting agent can be applied separately. Alternatively, the pore-promoting agent can be part of the fusing agent. For example, a fusing agent can include water, a radiation absorber, and a pore-promoting compound that generates a gas at an elevated temperature. In such examples, the pore-promoting agent can be applied with the fusing agent. In other examples, the fusing agent can include the pore-promoting compound that is applied at one step and such a method can include a second step that also applies the pore-promoting agent with a pore-promoting compound. Such a technique can use the fusing agent with the pore-promoting compound to all regions while the pore-promoting agent can be applied selectively to different regions to form different regions with different amounts of pores to control the dielectric permittivity.

A detailing agent can also be jetted onto the build material. As described above, the detailing agent can be a fluid that reduces the maximum temperature of the polymer particles on which the detailing agent is printed. In particular, the maximum temperature reached by the powder during exposure to electromagnetic energy can be less in the areas where the detailing agent is applied. In certain examples, the detailing agent can include a solvent that evaporates from the polymer particles to cool the polymer particles. The detailing agent can be printed in areas of the build material where fusing is not desired. In particular examples, the detailing agent can be printed along the edges of areas where the fusing agent is printed. This can give the fused layer a clean, defined edge where the fused polymer particles end and the adjacent polymer particles remain unfused. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas.

The elevated temperature at which the pore-promoting compound chemically reacts can be from about 80° C. to about 250° C. The pore-promoting compound and the build material onto which the pore-promoting compound was jetted can reach this elevated temperature when the radiation energy is applied to the build material. The elevated temperature can be at or near the melting or softening point of the polymer particles in the build material. In other examples, the elevated temperature can be above or below the melting or softening point of the polymer particles. In any of these examples, the pore-promoting compound can be heated to a sufficient temperature to react and form a gas while the polymer particles are in a melted or softened state so that gas bubbles can form in the melted or softened polymer to form pores.

A variety of variables of the “print mode” can be adjusted to affect the level of porosity in the three-dimensional printed object using the hardware controller. The methods of making three-dimensional printed objects can include adjusting these variables to modify the level of porosity or to modify the size of the gas bubbles, e.g., to generate different amounts or pores in addition to any pores that are also formed. In certain examples, the variables can include the amount of fusing agent applied to the build material, the amount of pore-promoting agent applied to the build material, the thickness of individual layers of build material, the intensity and duration of radiation applied to the build material, the preheating temperature of the build material, and so on.

The fusing agent and pore-promoting agent can be jetted onto the build material using fluid jet print heads. The amount of pore-promoting agent jetted onto the powder can be calibrated based on the concentration of pore-promoting compound in the pore-promoting agent, the desired porosity of the resulting porous portion to be printed, among other factors. Similarly, the amount of the fusing agent used can be calibrated based the concentration of radiation absorber in the fusing agent, the level of fusing desired for the polymer particles, and/or other factors. The amount of fusing agent printed can be sufficient to contact the radiation absorber with the entire layer of polymer particles. For example, if an individual layer of polymer particles is 100 μm thick, the fusing agent may penetrate 100 μm into the polymer particles, or may penetrate more or less than 100 μm. The fusing agent can heat the polymer particles throughout the entire layer so that the layer can coalesce and bond to the layer below. After forming a solid layer, a new layer of loose powder can be formed, either by lowering the build material or by raising the height of a powder roller and rolling a new layer of powder.

The entire powder bed of build material can be preheated to a temperature below the melting or softening point of the polymer particles in some examples in preparation for application of the fusing agent and the pore-promoting agent. In some examples, the preheat temperature can be from about 10° C. to about 30° C. below the melting or softening point. In other examples, the preheat temperature can be within 50° C. of the melting or softening point. In some examples, the preheat temperature can be from about 160° C. to about 170° C. and the polymer particles can be nylon 12 powder. In other examples, the preheat temperature can be about 90° C. to about 100° C. and the polymer particles can be thermoplastic polyurethane. Preheating can be accomplished with a lamp or lamps, an oven, a heated support bed, or other types of heaters. In some examples, the entire build material at the upper surface of the powder bed can be heated to a substantially uniform temperature.

The build material can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the build material. Such a fusing lamp can make multiple passes over the bed depending on the amount of exposure used to coalesce the individual printed layer. The fusing lamp can be configured to irradiate the entire build material with a substantially uniform amount of energy. This can selectively coalesce the printed portions with fusing agent leaving the unprinted portions of the polymer particles below the melting or softening point.

The fusing lamp can be matched with the radiation absorber in the fusing agent so that the fusing lamp emits wavelengths of light that match the peak absorption wavelengths of the radiation absorber in some examples. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer particles, the absorbance of the radiation absorber, the preheat temperature, and/or the melting or softening point of the polymer, an appropriate amount of irradiation can be supplied from the fusing lamp. In some examples, the fusing lamp can irradiate individual layers from about 0.5 to about 10 seconds per pass.

The three-dimensional printed object can be formed by jetting a fusing agent onto layers of build material according to a three-dimensional object model. Three-dimensional object models can in some examples be created using computer aided design (CAD) software. Three-dimensional object models can be stored in any suitable file format. In some examples, a three-dimensional printed object as described herein can be based on a single three-dimensional object model. The three-dimensional object model can define the three-dimensional shape of the article and the three-dimensional shape of porous portions to be formed in the three-dimensional printed object. In other examples, the three-dimensional printed object can be defined by a first three-dimensional object model and the porous portions can be defined by a second three-dimensional object model. The portions where there will be a higher or lower density or volume of pores relative to other portions may be defined by a third three-dimensional object model. These object models can be referred to herein collectively as “three-dimensional object model,” whether there is one object model defining all of the printing functions or multiple object models used together. Other information may also be included, such as structures to be formed of additional different materials or color data for printing the article with various colors at different locations on the article. The three-dimensional object model may also include features or materials specifically related to jetting fluids on layers of build material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, concentration of the pore-promoting compound, and so on. All this information can be contained in a single three-dimensional object model file or a combination of multiple files. The three-dimensional printed object can be made based on the three-dimensional object model. As used herein, “based on the three-dimensional object model” can refer to printing using a single three-dimensional object model file or a combination of multiple three-dimensional object models that together define the article. In certain examples, software can be used to convert a three-dimensional object model to instructions for a three-dimensional printer to form the article by building up individual layers of build material.

A thin layer of polymer particles can be spread on a bed to form a build material. At the beginning of the process, the build material can be empty because no polymer particles have been spread at that point. For the first layer, the polymer particles can be spread onto an empty build platform. The build platform can be a flat surface made of a material sufficient to withstand the heating conditions of the three-dimensional printing process, such as a metal. Thus, “applying” individual build material layers of polymer particles to a build material includes spreading polymer particles onto the empty build platform for the first layer. In other examples, a number of initial layers of polymer particles can be spread before the printing begins. These “blank” layers of build material can, in some examples, number from about 10 to about 500, from about 10 to about 200, or from about 10 to about 100. In some cases, spreading multiple layers of powder before beginning the print can increase temperature uniformity of the three-dimensional printed object. A fluid jet print head, such as an inkjet print head, can be used to print a fusing agent including a radiation absorber over portions of the build material corresponding to a thin layer of the three-dimensional article to be formed. The bed can be exposed to electromagnetic energy, e.g., typically the entire bed. The electromagnetic energy can include light, infrared radiation, and so on. The radiation absorber can absorb more 2.5 energy from the electromagnetic energy than the unprinted powder. The absorbed light energy can be converted to thermal energy causing the printed portions of the powder to soften and fuse together into a formed layer. After the first layer is formed, a new thin layer of polymer particles can be spread over the build material and the process can be repeated to form additional layers until a complete three-dimensional article is printed. Furthermore, applying individual build material layers of polymer particles to a build material also includes spreading layers of polymer particles over the loose particles and fused layers beneath the new layer of polymer particles.

The three-dimensional printed object can be formed with porosity throughout the three-dimensional printed object, or with a porous portion of any desired volume, density or shape located in any desired location within the three-dimensional printed object. In some examples, the three-dimensional printed object can have a porous interior and a solid exterior surface. In other examples, porosity can be formed in the three-dimensional printed object for the purpose of reducing the weight of the article, increasing buoyancy of the article, decreasing strength of the article, increasing flexibility of the article, etc. In some examples, a certain portion of the article can be made highly porous to form a breakaway segment that can be snapped apart with moderate force. In other examples, a portion of the article can be made porous while other portions are non-porous to provide for a more flexible porous segment connected to more rigid non-porous segments. In other examples, a hidden label, code, or identification mark can be formed using the pore-promoting agent. For example, a porous portion of a particular shape can be formed in the interior of the three-dimensional printed object beneath the surface so that the porous portion is not visible to the human eye. The porous portion can be detected using detection equipment to find or read the hidden identification label or code. In this way, a porous label or code can be used to verify authenticity of a three-dimensional printed object or to store information about the three-dimensional printed object. Besides these examples, three-dimensional printed objects with porous portions can be used for a variety of additional applications.

### Three-Dimensional Printing Systems

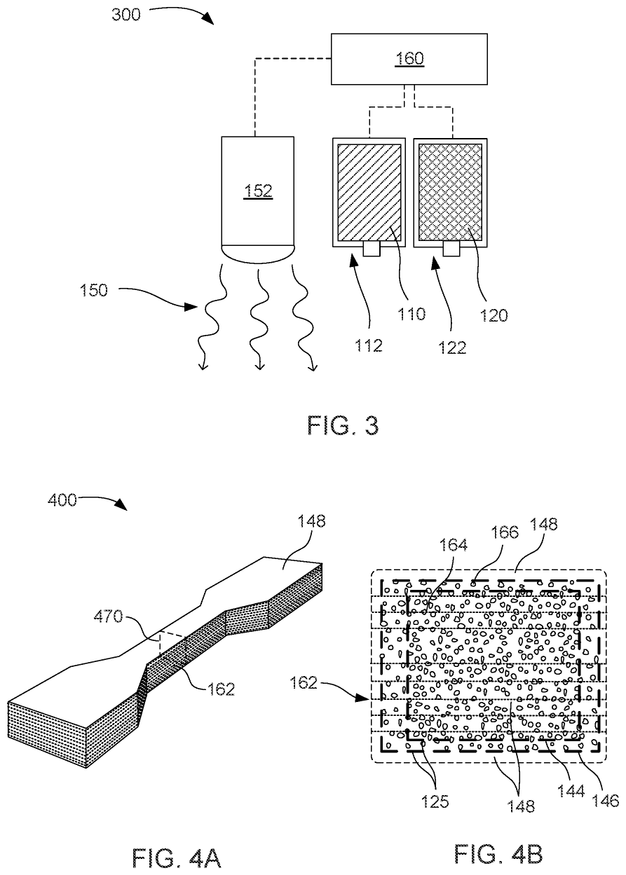

Referring now to FIG. 3, a three-dimensional printing system 300 is shown that can include some of the same features as that shown in FIGS. 1A-1C, for example. The three-dimensional printing system of these examples, however, include a fusing agent applicator 112 containing a fusing agent 110. The fusing agent can include water and a radiation absorber, for example. The system can also include a pore-promoting agent applicator 122 containing a pore-promoting agent 120. The pore-promoting agent can include water and a pore-promoting compound that generates a gas at an elevated temperature that can generate a command to direct the fusing agent applicator to iteratively and selectively apply the fusing agent to a build material forming individually patterned object layers, and direct the pore-promoting agent applicator to iteratively apply the pore-promoting agent to a discrete location within the individually patterned object layer at a concentration to generate a gas sufficient to form pores. The three-dimensional printing system can, in some examples, further include the build material (not shown, but shown in FIGS. 1A-1C), which may include from about 80 wt % to 100 wt % polymer particles having an average particle size from about 20 μm to about 150 μm. The system can also include an electromagnetic energy source 152. In some examples, a hardware controller 160 can direct the electromagnetic energy source to apply electromagnetic energy 150 to the build material including at locations where the radiation absorber and the pore-promoting compound are applied. The hardware controller may be the same component or a separate component for ejecting fluid(s) and/or emitting radiation, but whether there are multiple components or a single component, they can be collectively referred to as a “hardware controller.” Upon application of the electromagnetic energy to the radiation absorber, individually patterned object layers of the fusing agent can generate sufficient heat to soften or form a molten polymer from the build material to form a fused polymer body. At a temperature where there is molten polymer, the pore-promoting compound can also generate the gas, displacing the molten polymer and leaving the pores within the three-dimensional printed object, including at the discrete location upon cooling. A material used to form the fused polymer body without pores exhibits a material dielectric permittivity. The fused polymer body at a location that includes the pores can exhibit a decreased dielectric permittivity that is from about 5% to about 50% of the inherent material dielectric permittivity.

The hardware controller 152 can direct the pore-promoting agent applicator 122 to iteratively apply the pore-promoting agent 120 to a single discrete location or multiple discrete locations spanning multiple individually pattered object layers where the pore-promoting agent is to be selectively applied. This can result in one porous portion or multiple porous portions independently exhibiting the decreased dielectric permittivity, and/or another portion without the presence of the pores that exhibits the material dielectric permittivity. The multiple porous regions can exhibit different decreases in the dielectric permittivity relative to one another. The present technology can also result in reduced magnetic permeability, reduced electrical conductivity, modified photoluminescence, or a combination thereof at different regions relative to a fused polymer body with no pores. In some examples, the hardware controller can direct the application of the pore-promoting agent to control the decreased dielectric permittivity at a voxel scale for the resulting three-dimensional printed object.

### Three-Dimensional Printed Objects

A three-dimensional printed object 400 is shown at FIGS. 4A-4B, and can include multiple fused polyamide layers that are also fused to one another. The multiple fused polymer layers are shown between dotted lines where there may be an interface 162 where individual three-dimensional printed object layers are fused together. The multiple fused polymer layers 148 can include, for example, cooled molten polymer which can be referred to as a fused polymer body with gas-generated pores 166 therein. The cooled molten polymer can include the polyamide particles including polyamide-6, polyamide-9, polyamide-11, polyamide-12, polyamide-6,6, polyamide-6,12, polyamide copolyamide-12, amorphous polyamide, polyvinylidene fluoride copolyamide-12, thermoplastic polyamide elastomer, polypropylene, or a combination thereof. In other examples, the pores can be completely within the three-dimensional printed object and are not visible on any surface thereof. In some examples, shown generally at 125, the three-dimensional printed object can include multiple sub-regions. A first sub-region 146 can include pores 166 of one size and spacing while a second sub-region 144 can include pores 165 of a different size and spacing relative to pores 166. The second sub-region is depicted as having both pores 165 and 166. It should be appreciated that a sub-region may have more than one size of pores and that the size of pores may be the same or different as compared to different sub-regions. For example, the second sub-region need not include pores 166.

The can be areas that have essentially no pores, as shown around the outermost periphery of FIG. 4B. The fuse polymer 148 is present at this peripheral area but also extends throughout the three-dimensional printed object. The area with essentially no pores can exhibit a material dielectric permittivity. The first sub-region 146 with pores 166 can have a decreased dielectric permittivity relative to the area with no pores. The second sub-region 144 with pores 164 present at still a higher void volume or porous density can have a decreased dielectric permittivity relative to the first sub-region. It should be appreciated that the three-dimensional printed object 400 can have any number of sub-regions with different or the same volume of gas-generated localized pores. For example, a third sub-region can have a different volume of gas-generated localized pores relative to the second sub-region, where the dielectric permittivity of the third sub-region is different than at the second sub-region, but also exhibits a reduced dielectric permittivity relative to the material dielectric permittivity of the first sub-region.

### Build Materials

The polyamide particles can be present in the build material at from about 80 wt % to 100 wt %, from about 90 wt % to 100 wt %, from about 95 wt % to 100 wt %, from about 80 wt % to about 90 wt %, from about 85 wt % to about 95 wt %, or at about 100 wt %. Other particles other than the polyamide particles, if present, can be included such as filler, charging particles, flow aid particles, etc., as described in detail hereinafter.

The polyamide particles can be selected from various polyamide particles, such as polyamide-6, polyamide-9, polyamide-11, polyamide-12, polyamide-6,6, polyamide-6,12, thermoplastic polyamide elastomer, or a combination thereof. In other examples, the polyamide particles can be blended with other types of polymer particles, such as polyacrylate, polybutylene terephthalate, polycarbonate, polyester, polyethylene, polystyrene, polyurethane, copolymers thereof, blends of any of the multiple polymers listed herein, or mixtures thereof. Core shell polymer particles of these materials may also be used. In some examples, the build material does not include amorphous materials.

The polyamide particles (and other particles if present) of the build material can have an average particle size that can range from about 10 μm to about 150 μm. Polymeric particles can have an average particle size that can range from about 10 μm to about 150 μm, from about 10 μm to about 100 μm, from about 20 μm to about 80 μm, from about 30 μm to about 50 μm, from about 25 μm to about 75 μm, from about 40 μm to about 80 μm, from about 50 μm to about 75 μm, from about 75 μm to about 150 μm, from about 60 μm to about 90 μm, or from about 100 μm to about 150 μm, for example.

The terms “particle size” or “average particle size” as used herein, refer to the average diameter of a substantially spherical particle, or the effective diameter of a non-spherical particle, e.g., the diameter of a sphere with the same mass and density as the non-spherical particle as determined by weight. Particle size information can be determined and/or verified using a scanning electron microscope (SEM), or can be measured using a particle analyzer such as a MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles tend to scatter light at smaller angles, while smaller particles tend to scatter light at larger angles. The particle analyzer can analyze the angular scattering data to calculate the size of the particles using the Mie theory of light scattering. Particle size can be reported as a volume equivalent sphere diameter.

The polymer build material of the powder bed, including the polyamide particles, can include particles of a variety of shapes, such as spherical particles (average aspect ratio of about 1:1) or irregularly-shaped particles (average aspect ratios of about 1:1 to about 1:2). Other average aspect ratios can also be used, e.g., from about 1:1.2 to about 1:5, from about 1:1.5 to about 1:3, etc. If other particles are present, they can have a similar or different aspect ratio relative to the polyamide particles.

The polyamide particles in the build material can have a melting point that can range from about 75° C. to about 350° C., from about 100° C. to about 300° C., or from about 150° C. to about 250° C. As examples, the build material can be a polyamide having a melting point of about 170° C. to about 190° C., or a thermoplastic polyurethane that can have a melting point ranging from about 100° C. to about 165° C. A variety of thermoplastic polymers with melting points or softening points in these ranges can be used. In some examples, the build material can include polyamide particles, such as polyamide-12, which can have a melting point from about 175° C. to about 200° C. In other examples, elastomers such as thermoplastic polyamides can be used, which may have a melting point from about 135° C. to about 210° C. in some examples.

The build material may include, in addition to the polyamide particles, other particles such as filler particles, charging particles, flow aid particles, or a combination thereof. Charging particles, for example, may be added to suppress tribo-charging. Examples of suitable charging particles include aliphatic amines (which may be ethoxylated), aliphatic amides, quaternary ammonium salts (e.g., behentrimonium chloride or cocamidopropyl betaine), esters of phosphoric acid, polyethylene glycol esters, or polyols. Some suitable commercially available charging particles include HOSTASTAT® FA 38 (natural based ethoxylated alkylamine), HOSTASTAT® FE2 (fatty acid ester), and HOSTASTAT® HS 1 (alkane sulfonate), both from Clariant Int. Ltd. (North America). In some examples, if added, the charging particles can be included in an amount ranging from greater than 0 wt % to about 20 wt %, from about 0.1 wt % to about 10 wt %, or from about 0.2 to about 5 wt %, based upon the total wt % of the build material.

Flow aid particles may be added to increase the coating flowability of the build material. Flow aid particles may be particularly desirable when the particles of the build material are on the smaller end of the D50 particle size range. The flow aid particles can increase the flowability of the build material by reducing friction, lateral drag, and tribocharge buildup (by increasing the particle conductivity). Examples of suitable flow aid particles include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), or polydimethylsiloxane (E900). In some examples, if added, the flow aid particles can be included in an amount ranging from greater than 0 wt % to about 20 wt %, from about 0.1 wt % to about 10 wt %, or from about 0.2 to about 5 wt %, based upon the total wt % of the build material.

### Fusing Agents

The multi-fluid kits and materials kits for three-dimensional printing described herein can include a fusing agent to be applied to the polymer build material. The fusing agent can include a radiation absorber that can absorb radiant energy and convert the energy to heat. In certain examples, the fusing agent can be used with a build material in a particular three-dimensional printing process. A thin layer of build material can be formed, and the fusing agent can be selectively applied to areas of the build material that are desired to be consolidated to become part of the solid three-dimensional printed object. The fusing agent can be applied, for example, by printing such as with a fluid ejector or fluid jet printhead. Fluid jet printheads can jet the fusing agent in a similar way as an inkjet printhead jetting ink. Accordingly, the fusing agent can be applied with great precision to certain areas of the build material that are desired to form a layer of the final three-dimensional printed object. After applying the fusing agent, the build material can be irradiated with radiant energy. The radiation absorber from the fusing agent can absorb this energy and convert it to heat, thereby heating any polymer particles in contact with the radiation absorber. An appropriate amount of radiant energy can be applied so that the area of the build material that was printed with the fusing agent heats up enough to melt the polymer particles to consolidate the objects into a solid layer, while the build material that was not printed with the fusing agent remains as a loose powder with separate particles.

The amount of radiant energy applied, the amount of fusing agent applied to the build material, the concentration of radiation absorber in the fusing agent, and/or the preheating temperature of the build material (e.g., the temperature of the build material prior to printing the fusing agent and irradiating) can be tuned to ensure that the portions of the build material printed with the fusing agent will be fused to form a solid layer and the unprinted portions of the build material will remain a loose powder. These variables can be referred to as parts of the “print mode” of the three-dimensional printing system. Generally, the print mode can include any variables or parameters that can be controlled during three-dimensional printing to affect the outcome of the three-dimensional printing process.

The process of forming a single layer by applying a fusing agent and irradiating the build material can be repeated with additional layers of fresh build material to form additional layers of the three-dimensional printed object, thereby building up the final object one layer at a time. In this process, the build material surrounding the three-dimensional printed object can act as a support material for the object. When the three-dimensional printing is complete, the object can be removed from the build material, e.g., build material that was not incorporated into the three-dimensional printed object, and any loose powder on the object can be removed.

The fusing agent can include a radiation absorber to absorb electromagnetic radiation and produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In other examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, or a combination thereof. Non-limiting specific examples of phosphates can include M₂P₂O₇, M₄P₂O₉, M₅P₂O₁₀, M₃(PO₄)₂, M(PO₃)₂, M₂P₄O₁₂, or a combination thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein can be associated with counterions having an oxidation stated other than +2. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein can be associated with counterions having an oxidation stated other than +2. Other silicate counterions can also be used to prepare other suitable near-infrared pigments.

The radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly(ethylene glycol) p-isooctyl-phenyl ether, sodium polyacrylate, or a combination thereof.

The amount of radiation absorber in the fusing agent can vary depending on the type of radiation absorber. The concentration of radiation absorber in the fusing agent can be from about 0.1 wt % to about 20 wt %, from about 0.1 wt % to about 15 wt %, from about 0.1 wt % to about 8 wt %, from about 0.5 wt % to about 2 wt %, or from about 0.5 wt % to about 1.2 wt %. In other examples, the radiation absorber can have a concentration in the fusing agent such that after the fusing agent is jetted onto the polymer particles, the amount of radiation absorber in the polymer particles can be from about 0.0003 wt % to about 10 wt %, or from about 0.005 wt % to about 5 wt %, relative to the weight of the polymer particles.

The fusing agent can be jetted onto the polymer particles of the build material using a fluid jetting device, such as inkjet printing architecture. The fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

The liquid vehicle formulation can include a co-solvent or co-solvents present in total from about 1 wt % to about 50 wt %, depending on the jetting architecture. A non-ionic, cationic, and/or anionic surfactant can be present, ranging from about 0.01 wt % to about 5 wt %. In some examples, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In some examples, the liquid vehicle can be predominantly water.

A water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In other examples, a non-aqueous vehicle can be used with an organic-soluble or organic-dispersible fusing agent.

A high boiling point co-solvent can be included in the fusing agent. The high boiling point co-solvent can be an organic co-solvent that boils at or near a temperature higher than the temperature of the build material during printing. The high boiling point co-solvent can have a boiling point above about 250° C. In other examples, the high boiling point co-solvent can be present in the fusing agent at a concentration from about 1 wt % to about 10 wt %.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol, and/or 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); and/or sodium dodecylsulfate.

Various other additives can be included to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), or a combination thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present from about 0.01 wt % to about 20 wt %.

### Pore-Promoting Agents

The pore-promoting agent can include a water-soluble pore-promoting compound that can chemically react at an elevated temperature to generate a gas. As used herein, “chemically react” refers to a change in chemical composition and not a mere phase change from liquid or solid to gas. Many liquid solvents can evaporate to form a gas at an elevated temperature. However, the pore-promoting compound described herein does not refer to a liquid that evaporates at or near the elevated temperature. Instead, the pore-promoting compound undergoes a chemical reaction to form a different compound. The product of this chemical reaction can be a gas, and the gas can remain in a gaseous state even after cooling back to room temperature. In some examples, the chemical reaction of the pore-promoting compound can proceed without any other reactants besides the pore-promoting compound. In certain examples, the pore-promoting compound can chemically decompose to form smaller molecules, and the product molecules can include a gas.

Non-limiting examples of pore-promoting compounds can include carbohydrazide, urea, a urea homologue, a carbamide-containing compound, ammonium carbonate, ammonium nitrate, ammonium nitrite, bicarbonates, or the like. As used herein, “urea homologue” can refer to methylurea and dimethylurea. These compounds can chemically decompose to form a gas when heated to a decomposition temperature. In some examples, the gas formed can include carbon dioxide gas.

The pore-promoting agent can react to form a gas at or near an elevated temperature that is reached during the three-dimensional printing process. The elevated temperature at which the pore-promoting compound reacts can be from about 80° C. to about 250° C. In other examples, the elevated temperature can be from about 80° C. to about 250° C., from about 150° C. to about 250° C., or from about 190° C. to about 240° C. In certain examples, the elevated temperature can be at or near the melting or softening point temperature of the polymer particles in the build material. For example, the elevated temperature can be within 20° C., within 15° C., or within 10° C. of the melting or softening point of the polymer particles. Thus the pore-promoting compound can react when the polymer particles are fused during the three-dimensional printing process. In other examples, the elevated temperature at or near where the pore-promoting compound reacts can be higher than the melting or softening point of the polymer particles. During the three-dimensional printing process, a sufficient amount of fusing agent can be applied to the polymer particles and a sufficient amount of radiation energy can be applied to heat the pore-promoting compound to the temperature at or near which the pore-promoting compound will react.

The pore-promoting compound that is applied to the build material can react completely to form gas when the build material is heated during fusing of the polymer particles. In other words, all or nearly all of the pore-promoting compound can react to yield the gas. In other examples, a portion of the pore-promoting compound can react and another portion can remain unreacted. In certain examples, from about 50 wt % to about 100 wt % of the pore-promoting compound can react. In other examples, from about 60 wt % to about 95 wt % or from about 70 wt % to about 90 wt % of the pore-promoting compound can react. In some examples, less of the pore-promoting compound can react. For example, from about 10 wt % to about 70 wt %, or from about 20 wt % to about 60 wt %, or from about 30 wt % to about 50 wt % of the pore-promoting compound can react. The amount of the pore-promoting compound that reacts can in some cases depend on the temperature to which the build material is heated, the length of time that the powder is held at or near that temperature, the total amount of radiation energy applied to the build material, and so on. Accordingly, the amount of radiation energy applied, the length of time that the build material is heated, the temperature reached by the build material, the amount of fusing agent applied to the build material, and other variables can affect the extent of the reaction of the pore-promoting compound. Therefore, these variables can affect the porosity of the final three-dimensional printed object. These variables can be parts of the “print mode” of the three-dimensional printing process. The porosity can also be affected by changing the amount of pore-promoting agent that is applied to the build material. Accordingly, the print mode can be adjusted to affect the level of porosity in the three-dimensional printed object.

The total amount of pore-promoting compound that is present in the build material can directly affect the porosity of the three-dimensional printed object. As mentioned above, this variable can be adjusted by changing the amount of pore-promoting agent that is applied to the build material. Alternatively, the amount of pore-promoting compound applied to the build material can be changed by changing the concentration of pore-promoting compound in the pore-promoting agent. The amount of pore-promoting compound can be selected to allow the pore-promoting agent to be jettable from a fluid jet printhead. In certain examples, the concentration of the pore-promoting compound in the pore-promoting agent can be from about 0.5 wt % to about 30 wt % relative to the total weight of the pore-promoting agent. The concentration of pore-promoting compound can be from about 0.5 wt % to about 25 wt %, from about 1 wt % to about 20 wt %, from about 1 wt % to about 15 wt %, from about 2 wt % to about 10 wt %, from about 10 wt % to about 30 wt %, or from about 5 wt % to about 25 wt %.

The pore-promoting agent can also include ingredients to allow the pore-promoting agent to be jetted by a fluid jet printhead. The pore-promoting agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

### Other Fluid Agents

Methods of three-dimensional printing and the printing systems of the present disclosure can utilize additional fluid agents as may be applicable for a given application, e.g., coloring agent, detailing agent, second pore-promoting agent, etc. For example, a coloring agent may include a colorant and an aqueous liquid vehicle. In addition to water, the aqueous liquid vehicle can include organic cosolvent, surfactant, and/or other components usable with jetting architecture, and as disclosed previously regarding other fluid agents described herein. A detailing agent may be used and can include a detailing compound. The detailing compound can reduce the temperature of the build material onto which the detailing agent is applied. If used, the detailing agent can be printed around the edges of the portion of the powder that is printed with the fusing agent. The detailing agent can increase selectivity between the fused and unfused portions of the build material by reducing the temperature of the powder around the edges of the portion to be fused.

The detailing compound can be a solvent that evaporates at or near the temperature of the build material. In some cases the build material can be preheated to a preheat temperature within about 10° C. to about 70° C. of the fusing temperature of the polymer particles. Depending on the type of polymer particles used, the preheat temperature can be in the range of about 90° C. to about 200° C. or more. The detailing compound can be a solvent that evaporates when it comes into contact with the build material at or near the preheat temperature, thereby cooling the printed portion of the build material through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N, N-dimethyl acetamide, and combinations thereof. The detailing agent can be mostly water. In other examples, the detailing agent can be about 85 wt % water or more. In some examples, the detailing agent can be about 95 wt % water or more. In other examples, the detailing agent can be substantially devoid of radiation absorbers. The detailing agent can be substantially devoid of ingredients that absorb enough radiation energy to cause the powder to fuse. In certain examples, the detailing agent can include colorants such as dyes or pigments, but in small enough amounts that the colorants do not cause the powder printed with the detailing agent to fuse when exposed to the radiation energy.

The detailing agent can also include ingredients to allow the detailing agent to be jetted by a fluid jet printhead. The detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

### Definitions

It is noted that, as used in this specification and the appended claims, the singular forms “a,” “an,” and “the” include plural referents unless the context clearly dictates otherwise.

As used herein, “colorant” can include dyes and/or pigments.

As used herein, “jetting” refers to compositions that are ejected from jetting architecture, such as inkjet architecture. Inkjet architecture can include thermal or piezo architecture. Additionally, such architecture can be configured to print varying drop sizes such as less than 10 picoliters, less than 20 picoliters, less than 30 picoliters, less than 40 picoliters, less than 50 picoliters, etc.

As used herein, the term “substantial” or “substantially” when used in reference to a quantity or amount of a material, or a specific characteristic thereof, refers to an amount or characteristic that is sufficient similar to the absolute value or characteristic given to provide an effect that the material or characteristic would otherwise provide. The exact degree of deviation allowable may in some cases depend on the specific context. When using the term “substantial” or “substantially” in the negative, e.g., substantially devoid of a material, what is meant is that none of that material is present, or at most, trace amounts could be present at a concentration that would not impact the function or properties of the composition as a whole.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, “applying” when referring to fluid agent, such as a coalescing agent that may be used, for example, refers to any technology that can be used to put or place the fluid, e.g., coalescing agent, on the polymeric build material or into a layer of polymer build material for forming a three-dimensional object. For example, “applying” may refer to a variety of dispensing technologies, including “jetting,” “ejecting,” “dropping.” “spraying.” or the like.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if a numerical value and sub-range is explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Example 1—Materials for Printing Three-Dimensional Printed Objects

A fusing agent, pore-promoting agents, and a build material can be used to prepare three-dimensional printed objects. An example fusing agent is shown below in Table 1, and several example pore-promoting agents are shown below in Tables 2A-2C, some of which include a radiation absorber as well as the pore-promoting compound. These fluid agents can be used for printing using build material including polymer particles, such as thermoplastic polyurethane (TPU), which is a block copolymer of alternating sequences of hard segments (isocyanate) and soft segments (reacted polyol). The isocyanates can be aliphatic or aromatic, depending on the specific TPU selected for use.

TABLE 1
Fusing Agent

| Ingredient | Concentration (wt %) |
|---|---|
| Carbon Black Dispersion | 5 |
| (12.8 wt % carbon black particles) | (Radiation Absorber Content) |
| Organic Co-solvent | 5-45 |
| Surfactant | 0.01-2 |
| Chelating Agent | 0-1 |
| Biocide | 0-1 |
| Deionized Water | Balance |

TABLE 2A
Pore-promoting Agent 1 (with Radiation Absorber)

| Ingredient | Concentration (wt %) |
|---|---|
| Carbon Black Dispersion | 1-10 |
| (12.8 wt % carbon black particles) | (Radiation Absorber Content) |
| Urea | 2-30 |
| Organic Co-solvent | 5-45 |
| Surfactant | 0.01-2 |
| Chelating Agent | 0-1 |
| Biocide | 0-1 |
| Deionized Water | Balance |

TABLE 2B
Pore-promoting Agent 2 (without Radiation Absorber)

| Ingredient | Concentration (wt %) |
|---|---|
| Urea | 0.5-25 |
| Organic Co-solvent | 5-45 |
| Surfactant | 0.01-2 |
| Chelating Agent | 0-1 |
| Biocide | 0-1 |
| Deionized Water | Balance |

TABLE 2C
Pore-promoting Agent 3 (without Radiation Absorber)

| Ingredient | Concentration (wt %) |
|---|---|
| Urea | 0.5-25 |
| Sodium bicarbonate | 0.01-0.1 |
| Organic Co-solvent | 5-40 |
| Surfactant | 0.01-2 |
| Chelating Agent | 0-1 |
| Biocide | 0-1 |
| Deionized Water | Balance |

### Example 2—Variable Dielectric Permittivity of Three-Dimensional Printed Objects

A three-dimensional printed object including multiple fused layers of polyamide polymer is formed on a layer-by-layer basis using the polyamide particles and the Fusing Agent of Table 1 and Pore-promoting Agent 1 of Table 2A. More specifically, a cooled molten polymer with a first region without gas-generated localized pores is formed using the Fusing agent of Table 1, and a second region with gas-generated localized pores is formed using Pore-promoting Agent 1 of Table 2A, which also includes the carbon black radiation absorber. Notably, instead of using Pore-promoting Agent 1 of Table 2A, the second region could likewise be prepared by using Pore-promoting Agent 2 or 3 of Tables 2B or 2C in combination with the Fusing Agent of Table 1 so that the radiation absorber is applied to all locations where fusing of the layer should occur. The pores in the second region are formed at or near an elevated temperature at which the pore-promoting compound generates gas. Example elevated temperatures used may be from about 80° C. to about 250° C., for example. The first region in this example does not generate pores as no pore-generating compound is applied in this region. Thus, the first region exhibits a dielectric permittivity that is inherent in the material of the fused polymer body. However, the second region can include a field of pores having a volume density or porosity from about 0.5 vol % to about 50 vol %, depending on the amount of pore-promoting agent applied, the temperature used, etc. With the increased or higher porosity of the second region, the dielectric permittivity in that region will be decreased compared to that of the first region ranging from about 5% to 50% of the material dielectric permittivity of the first region.

What is claimed is:

1. A method of making a three-dimensional printed object comprising:
iteratively applying individual build material layers of polyamide particles to a powder bed;
based on a three-dimensional object model, selectively applying a fusing agent onto the individual build material layers to form individually patterned object layers of the three-dimensional printed object, wherein the fusing agent comprises water and a radiation absorber;
based on the three-dimensional object model, selectively applying a pore-promoting agent onto the individual build material layers at some or all of the individually pattered object layers to form a pore-generating region, wherein the pore-promoting agent comprises water and a pore-promoting compound that generates a gas at an elevated temperature; and
iteratively exposing the individual build material layers to electromagnetic energy to generate molten polymer from polyamide particles in contact with the radiation absorber that upon cooling forms fused polymer body, wherein within the molten polymer, the pore-promoting compound reaches the elevated temperature and generates the gas and displaces the molten polymer, leaving pores within the three-dimensional printed object, wherein a material used to form the fused polymer body without pores exhibits a material dielectric permittivity, and the fused polymer body at a location that includes the pores exhibits a decreased dielectric permittivity that is from about 5% to about 50% of the inherent material dielectric permittivity.

2. The method of claim 1, wherein the pore-generating region includes a single discrete location or multiple discrete locations spanning a single layer or multiple build material layers where the pore-promoting agent was selectively applied resulting in a porous portion or portions with the decreased dielectric permittivity or multiple different decreased dielectric permittivities, and wherein the three-dimensional printed object also includes a portion without the pores exhibiting the material dielectric permittivity.

3. The method of claim 1, wherein in addition to the decreased dielectric permittivity, at a same location, the fused polymer body exhibits reduced magnetic permeability, reduced electrical conductivity, modified photoluminescence, or a combination thereof.

4. The method of claim 1, wherein the pore-promoting compound is present in the pore-promoting agent in an amount from about 0.5 wt % to about 25 wt % relative to a total weight of the pore-promoting agent.

5. The method of claim 1, wherein the pore-promoting compound includes a carbohydrazide, urea, a urea homologue, a carbamide-containing compound, ammonium carbonate, ammonium nitrate, ammonium nitrite, a bicarbonate, or a combination thereof.

6. The method of claim 1, wherein the elevated temperature at which the pore-promoting compound generates the gas is from about 80° C. to about 250° C.

7. The method of claim 1, wherein:
the polyamide particles include polyamide-6, polyamide-9, polyamide-11, polyamide-12, polyamide-6,6, polyamide-6,12, polyamide copolyamide-12, amorphous polyamide, polyvinylidene fluoride copolyamide-12, thermoplastic polyamide elastomer, polypropylene, or a combination thereof;
the radiation absorber includes a metal dithiolene complex, carbon black, a near-infrared absorbing dye, a near-infrared absorbing pigment, metal nanoparticles, a conjugated polymer, or a combination thereof; or
both.

8. The method of claim 1, wherein the pore-promoting agent is part of the fusing agent.

9. A three-dimensional printing system comprising:
a fusing agent applicator loaded or loadable with a fusing agent including water and a radiation absorber;
a pore-promoting agent applicator loaded or loadable with a pore-promoting agent including water and a pore-promoting compound that generates a gas at an elevated temperature; and
an electromagnetic energy source to expose build material of polyamide particles with electromagnetic energy; and
a hardware controller to generate a command to:
direct the fusing agent applicator to iteratively and selectively apply the fusing agent to a build material forming individually patterned object layers, the fusing agent comprises water and a radiation absorber,
direct the pore-promoting agent applicator to iteratively and selectively apply the pore-promoting agent to the build material of the individually patterned object layer, the pore-promoting agent including water and a pore-promoting compound, and
direct the electromagnetic energy source to expose the build material with electromagnetic energy to selectively provide an elevated temperature sufficient to generate molten polymer from polyamide particles in contact with the radiation absorber that upon cooling forms fused polymer body, wherein within the molten polymer, the pore-promoting compound reaches the elevated temperature and generates the gas and displaces the molten polymer leaving pores within the three-dimensional printed object, wherein a material used to form the fused polymer body without pores exhibits a material dielectric permittivity, and the fused polymer body at a location that includes the pores exhibiting a decreased dielectric permittivity that is from about 5% to about 50% of the inherent material dielectric permittivity.

10. The three-dimensional printing system of claim 9, wherein the hardware controller further generates a command to:
direct the pore-promoting agent applicator to iteratively apply the pore-promoting agent to a single discrete location or multiple discrete locations spanning multiple individually pattered object layers where the pore-promoting agent is to be selectively applied resulting in one porous portion or multiple porous portions independently exhibiting the decreased dielectric permittivity, and another portion without the presence of the pores that exhibits the material dielectric permittivity.

11. The three-dimensional printing system of claim 9, wherein in addition to the reduced dielectric permittivity, at a same location, the fused polymer body exhibits reduced magnetic permeability, reduced electrical conductivity, modified photoluminescence, or a combination thereof.

12. The three-dimensional printing system of claim 9, wherein the pore-promoting compound includes a carbohydrazide, urea, a urea homologue, a carbamide-containing compound, ammonium carbonate, ammonium nitrate, ammonium nitrite, a bicarbonate, or a combination thereof.

13. The three-dimensional printing system of claim 9, wherein the hardware controller directs the application of the pore-promoting agent to control the decreased dielectric permittivity at a voxel scale.

14. A three-dimensional printed object comprising multiple fused layers of polyamide polymer, including a cooled molten polymer with a first region without gas-generated localized pores and a second region with gas-generated localized pores, wherein the first region exhibits a material dielectric permittivity and the second region exhibits a decreased dielectric permittivity that is from about 5% to 50% of the material dielectric permittivity.

15. The three-dimensional printed object of claim 14, further comprising a third region with a different volume of gas-generated localized pores relative to the second region, wherein the dielectric permittivity of the third region is different than at the second region, but also exhibits a reduced dielectric permittivity relative to the material dielectric permittivity of the first region.
